(19) United States
(12) Patent Application Publication
(10) Pub. No.: US 2014/0203085 A1
(43) Pub. Date: Jul. 24, 2014

(54) QR CODE DISPLAY OBJECT, METHOD OF SELLING QR CODES USING SAME AND METHOD OF PROVIDING INFORMATION THEREOF

(71) Applicant: Byung Ho Park, Namyangju Si (KR)

(72) Inventor: Byung Ho Park, Namyangju Si (KR)

(21) Appl. No.: 14/232,676

(22) PCT Filed: May 17, 2012
(86) PCT No.: PCT/KR2012/003900

§ 371 Date: Jan. 14, 2014

(30) Foreign Application Priority Data
Aug. 1, 2011 (KR) 10-2011-0076396
Sep. 21, 2011 (KR) 10-2011-0095005

(51) Int. Cl. G06K 19/06; G06Q 30/06; G06K 7/14

(52) U.S. Cl. CPC G06K 19/06037; G06K 7/1417; G06Q 30/0601
USPC 235/462.1; 235/494

(57) ABSTRACT

Provided is a QR code display object which is manufactured with a quality capable of verifying recognition of various sizes of expanded/reduced QR codes in advance and can be commercially distributed.

The QR code display object displays the generated QR code in advance to be recognized from the outside, and provides an editing URL representing an editing website which is capable of editing information to be displayed on a reader when scanning the QR code, and an ID exhibiting authority to edit the information to be displayed when scanning the QR code in the editing URL.

### TECHNICAL FIELD

The present invention relates to a QR code display object, a QR code selling method and an information providing method using the same, and more particularly to a QR code display object which is manufactured such that a pre-generated QR code included therein can be externally recognized, a method of selling a QR code along with access authority for a QR code management site where information to be displayed when the QR code is recognized by a reader can be edited and stored, and a method of collecting information stored in the QR code management site and providing the collected information on the Internet.

### BACKGROUND ART

In general, a QR (Quick Response) code is a graphic code including a larger amount of information than an existing barcode, and can contain texts, photos, moving pictures, maps, and contact information, as well as link URL information, so that its user classes and application areas are increasingly expanded. When this QR code is scanned by a reader, information contained therein is displayed in the reader. A software reader installed in a camera built-in smart phone has recently come into wide use.

In recent years, there has been a desire to attach such a QR code to products. As an example, a QR code attached to the surface of a mug is intended to not only prevent the mug from being confused with another person's mug, but also show the individuality of the mug through information displayed when the QR code is scanned. To this end, a method may be considered, in which a QR code is generated directly by the owner of a product, the generated QR code is reduced/enlarged and printed, and then the printed QR code is attached to the corresponding product by using an adhesive such as a self-adhesive tape or an adhesive agent.

There may be various QR code display methods according to which medium is used for QR code display. When a QR code is displayed on a sticker to be attached to the surface of a corresponding product, the display medium corresponds to a sheet such as paper, and the display method corresponds to printing or the like. When a QR code is displayed on a transfer sheet to be transferred to the surface of a corresponding product, the display medium corresponds to a sheet such as transfer paper, and the display method corresponds to printing with transfer ink or the like. When a QR code is displayed on a panel to be attached to the surface of a corresponding product, the display medium correspond to an acrylic panel or a metal panel, and the display method includes printing and may also include working such as embossing or intaglio work.

In addition, a QR code may be displayed directly on a corresponding product without any medium. As an example, a QR code may be displayed on the surface of a mug by printing with enamel or porcelain ink.

However, in the above various display methods, even when a transparent layer is interposed between a QR code and an observer, for example, a transparent layer covering a QR code is coated, the QR code falls within the concept of “a QR code displayed on a surface”, regardless of the thickness of the transparent layer.

At the entrance of a building, or near or inside the elevator of a building, an information board providing information on office occupants of the building is provided. Further, at the entrance of a traditional market, an information board providing information on store occupants of the market is also provided. Further, at the entrance of a large office, a layout showing seating arrangements of employees is also provided. In this way, at the entrance of an area consisting of spatially divided units, an information material providing information on the members of the area needs to be provided.

Such an information material is mostly made of wood, metal, plastics, or the like, and may be manufactured by printing, as well as working such as embossing or intaglio work. In addition, the information material may also be coated with a surface protective material such as acrylic resin.

However, a frequent change in the status of the members of such an area is caused by the expiration of the agreement term and the like. Of course, it is preferable to immediately reflect this change in the information material.

### DISCLOSURE OF INVENTION

### Technical Problem

Since a QR code is expressed in a graphic form from which encoded digital information can be optically recognized, there is the risk that when a non-expert reduces/enlarge the QR code, resolution may deteriorate and recognizability by a reader may be significantly lowered.

Further, separate decorative graphic elements may be added to the inside or outside of a QR code, but there is the risk that working carried out by a non-expert may significantly lower recognizability by a reader.

Further, a QR code can contain a large amount of information of various types but ordinary users do not properly use even half of the contained information, and thus there is a need to induce users to utilize the remaining unused part.

When a medium for displaying a QR code is a panel such as an acrylic panel or a metal panel, a method of displaying a QR code may include printing, as well as working such as embossing or intaglio work, which makes it impossible for a non-expert to carry out such working.

Further, when a QR code is displayed directly on a corresponding product without any medium, special processing such as printing with enamel or porcelain ink needs to be carried out for the corresponding planar or curved product, which also makes it impossible for a non-expert to carry out such processing.

Further, it is also impossible for a non-expert to coat a QR code, displayed on a planar sheet, a flat plate-like medium, or a corresponding planar or curved product, with a transparent layer.

In the case of an information material provided at the entrance of an area consisting of spatially divided units (e.g., a building) for providing information on the members (e.g., office occupants), there is a problem in that when there is a change in the status of the members, an information material in which the change is reflected must be remanufactured as a concrete object. In particular, even when the change corresponds to only a small fraction of the members, a new information material must be remanufactured as a whole. Of course, some information materials consist of prefabricated partially replaceable parts, but even in this case, parts to be replaced must be remanufactured. This remanufacturing of an information material is troublesome, and causes a problem of a waste of money, time, and resources.

In particular, since an information material has great influence on the information of the corresponding building, and thus using a material giving a good impression along with design factors is required to manufacture the information material, its manufacturing cost is very expensive. It will be appreciated that since the designs and contents of information materials are different from building to building, the mass production of information materials is impossible, and thus manufacturers also have difficulties in reducing the unit cost of production.

Accordingly, the present invention provides a QR code display object in which reduced/enlarged QR codes of various sizes or QR codes decorated with various internal/external design elements are displayed in advance with validated quality of recognition on a planar sheet, a flat plate, a three-dimensional object, or the like, and are inexpensively manufactured and distributed in the form of a ready-made product.

Further, the present invention provides a method of selling a QR code by using the QR code display object, which allows a user to purchase the QR code display object and QR codes in order to edit information to be displayed when the QR codes are scanned, reconstruct the information into contents in which the user's own information is reflected, and use the reconstructed information.

Further, the present invention provides a method of selling a QR code, which allows a seller to provide usage guides by previously filling a part of information, which is to be displayed when the QR code is scanned, with information for examples of use.

Further, the present invention provides a method of selling a QR code, which allows a seller to restrict a part of the information previously filled by the seller from being edited by a purchaser and continuously manage the information or information connected therewith, thereby utilizing them to provide specific advertisements or useful information.

Further, the present invention provides a method of providing information, in which information edited and stored by a purchaser is collected with the consent of the purchaser, and the collected information is provided on the Internet.

### Solution to Problem

In order to solve the above technical problem, in accordance with an aspect of the present invention, there is provided a QR (Quick Response) code display object including: a QR code that is generated in advance and is displayed to be externally recognizable; an editing URL (Uniform Resource Locator) representing an editing website where information to be displayed in a reader when the QR code is scanned by the reader can be edited; and an ID (Identification) representing authority to edit the information to be displayed in the reader when the QR code is scanned by the reader.

The QR code may be decorated with at least one design element of a form, a shape, and a color inside or outside thereof.

Further, the editing URL may be included in the QR code such that an editing screen of the editing URL appears in the reader when the QR code is scanned by the reader.

Further, the information to be displayed in the reader when the QR code is scanned by the reader may include list information showing a status of members of an area consisting of spatially divided units.

Further, example information for various types of information containable in the QR code may be included in advance in the information to be displayed in the reader when the QR code is scanned by the reader.

In accordance with another aspect of present invention, there is provided a method of selling a QR code by using the QR code display object, the method including: a selling step of distributing and selling the QR code display object; an accessing step of accessing the editing URL by a purchaser of the QR code display object; a logging-in step of logging-in to the editing website by using the ID; and an editing and storing step of editing the information to be displayed in a reader when the QR code is scanned by the reader and storing the edited information.

In the logging-in step, whether or not the purchaser has a regular ID capable of accessing the editing URL for all the QR codes possessed by the purchaser may be checked, the regular ID may be generated when the purchaser does not have the regular ID, and the ID acquired by purchasing the QR code display object may be connected with the regular ID.

Further, in the editing and storing step, at least a part of example information included in advance and supplied by a seller as the information to be displayed in the reader when the QR code is scanned by the reader may be set to be non-editable.

With regard to this, in the editing and storing step, at least a part of the information set to be non-editable may be managed by the seller.

In accordance with yet another aspect of the present invention, there is provided a method of providing information by using the QR code display object, the method including: an approving step of obtaining a purchaser's approval for authority to use information edited and stored by the purchaser in the editing and storing step; a collecting step of collecting information for which the purchaser's approval is obtained; and a post-processing step of providing the collected information on the Internet.

In order to provide the collected information in the post-processing step, the QR code may be displayed on the Internet.

### Advantageous Effects of Invention

According to the present invention, reduced/enlarged QR codes of various sizes or QR codes decorated with various internal/external design elements can be displayed in advance with validated quality of recognition on a planar sheet, a flat plate, a three-dimensional object, or the like, and can be inexpensively manufactured and distributed in the form of a ready-made product.

Further, a user can purchase the QR code display object and QR codes in order to edit information to be displayed when the QR codes are scanned, reconstruct the information into contents in which the user's own information is reflected, and use the reconstructed information.

Further, a seller can provide usage guides by previously filling a part of information, which is to be displayed when the QR code is scanned, with information for examples of use.

Further, a seller can restrict a part of the information previously filled by the seller from being edited by a purchaser and continuously manage the information or information connected therewith, thereby utilizing them to provide specific advertisements or useful information.

Further, a seller can collect information edited and stored by a purchaser with the consent of the purchaser and provide the collected information on the

Internet.

### BRIEF DESCRIPTION OF THE DRAWINGS

FIG. 1 is a block diagram illustrating a system to which the present invention is applied.

FIG. 2 is a view illustrating examples of various types of QR code display objects according to the present invention.

FIG. 3 is a view illustrating an example of an editing screen for a ready-made QR code that is included in and provided through a QR code display object according to the present invention.

FIG. 4 is a view illustrating a first example of a screen displayed when edition for a ready-made QR code, which is included in and provided through a QR code display object according to the present invention, is completed and then the QR code is scanned.

FIG. 5 is a view illustrating a second example of a screen displayed when edition for a ready-made QR code, which is included in and provided through a QR code display object according to the present invention, is completed and then the QR code is scanned.

FIG. 6 illustrates an operational flowchart of a method of selling a QR code by using a QR code display object according to the present invention.

### MODE FOR THE INVENTION

Hereinafter, a QR code display object, a QR code selling method and an information providing method using the same will be described in detail with reference to the accompanying drawings.

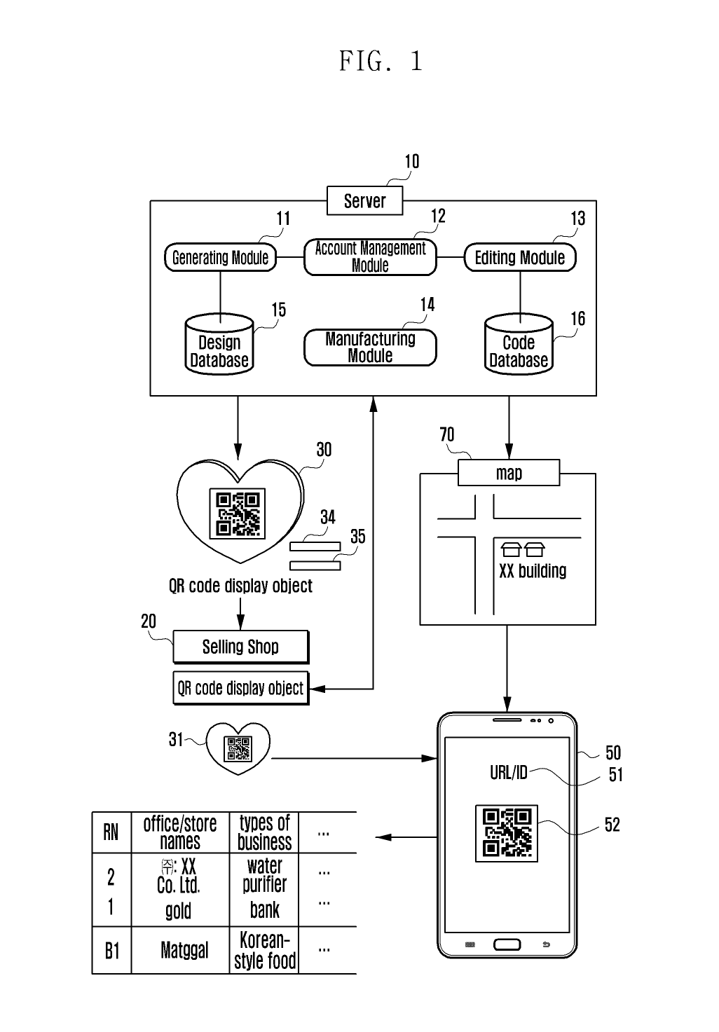

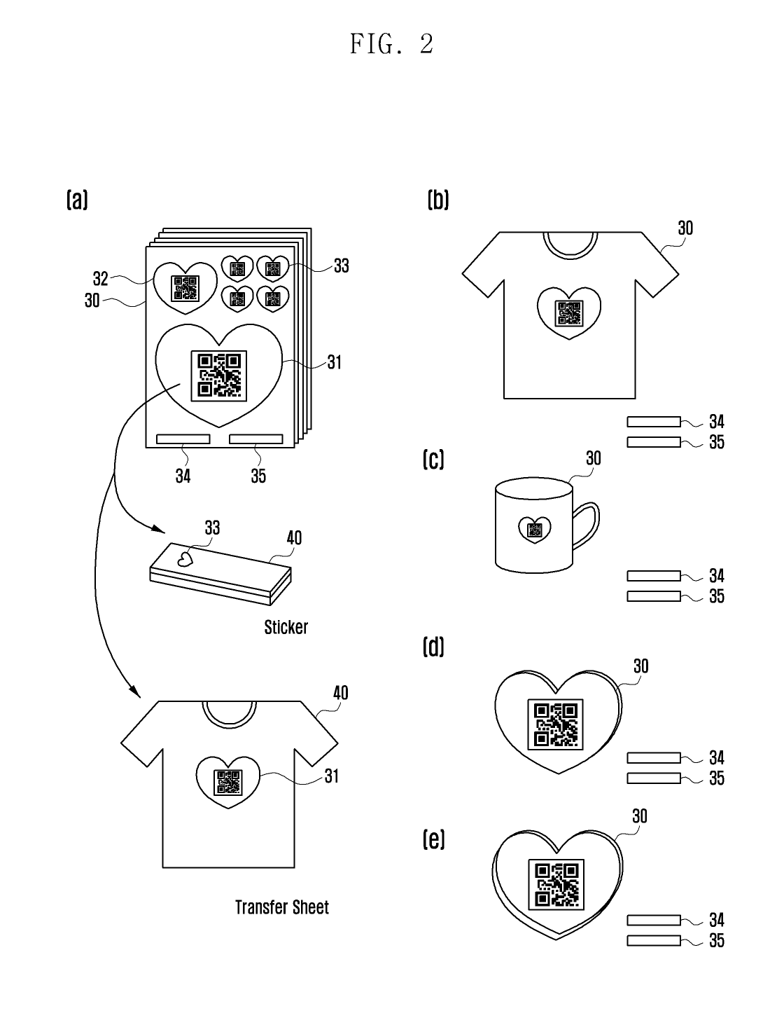

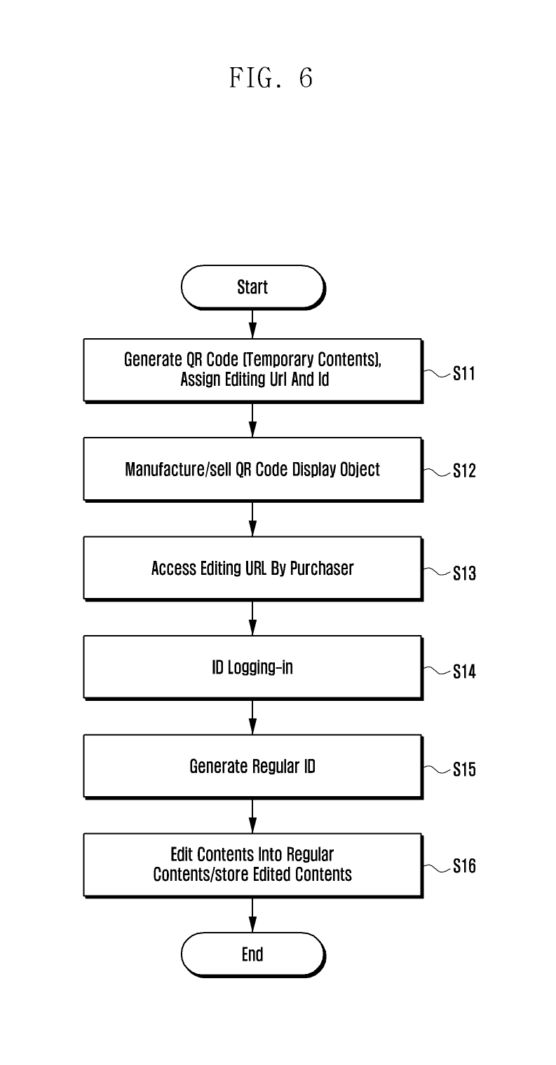

FIG. 1 illustrates a system to which the present invention is applied. FIG. 2 illustrates examples of various types of QR code display objects according to the present invention. FIG. 6 illustrates an operational flowchart of a method of selling a QR code by using a QR code display object according to the present invention.

The QR code display object 30 is an object including a QR code that is generated in advance and is displayed to be externally recognized. The QR code display object is characterized by including an editing URL 34 and an ID 35 along with the ready-made QR code.

The QR code is a ready-made QR code generated in advance and provided by a provider. Here, since the QR code is provided such that information to be displayed in a reader when the QR code is scanned by the reader is filled with “temporary” contents, it may be called the “temporary QR code”. However, this does not mean that the external form of the QR code is temporary, and even after the AR code is edited as described below, the external form of the QR code is not changed, but only information to be displayed in a reader when the QR code is scanned by the reader is changed.

The QR code display object 30 of the present invention is a product with a QR code displayed thereon, and may be implemented in various types as illustrated in FIG. 2.

As shown in FIG. 2(a), the QR code may be displayed on a sheet such as paper or vinyl, and in this case, the QR code display object 30 has a sheet-like shape. When the QR code display object 30 is a product on which the QR code is to be finally displayed, for example, letter paper or report paper, the QR code display object 30 itself is the corresponding product.

However, when the QR code display object 30 is not a product on which the QR code is to be finally displayed, the QR code display object 30 itself is only a display medium. For example, this medium may be provided in the form of a sticker or transfer sheet. In this case, as illustrated in the drawing, a plurality of QR code display objects 30 of various sizes, for example, a large-scale QR code display object 31, a medium-scale QR code display object 32, and a small-scale QR code display object 33, which are detachably disposed, may be simultaneously provided as a set of QR code display objects 30 in one sheet.

When the QR code display object 30 is provided, for example, in the form of a sticker, the corresponding product 40 is a product having a flat surface, for example, a pencil case, a notebook, or a motor vehicle outer wall, and a method of displaying the QR code on the QR code display object 30 is printing or the like.

When the QR code display object 30 is provided, for example, in the form of a transfer sheet, the corresponding product 40 is a product having a flexible surface, for example, cloth, a suit of clothes, or a curtain, and a method of displaying the QR code on the QR code display object 30 is printing with transfer ink or the like.

As shown in FIG. 2(d), the QR code may be displayed on a panel such as an acrylic panel or a metal panel, and in this case, the QR code display object 30 has a plate-like shape. When the QR code display object 30 is a product on which the QR code is to be finally displayed, for example, a pendant, a mouse pad, or a signboard, the QR code display object 30 itself is the corresponding product.

However, when the QR code display object 30 is not a product on which the QR code is to be finally displayed, the QR code display object 30 itself is only a display medium. For example, this medium may be provided in the form of a self-adhesive plate. In this case, as illustrated in FIG. 2(a), a plurality of QR code display objects 30 of various sizes, for example, a large-scale QR code display object 31, a medium-scale QR code display object 32, and a small-scale QR code display object 33, which are detachably disposed, may be simultaneously provided as a set of QR code display objects 30 in one sheet.

When the QR code display object 30 is provided, for example, as an information board or an information material in the form of a self-adhesive plate, the corresponding product 40 is a fixing wall having a flat surface, for example, a pencil case, a building wall, an elevator inner wall, and a method of displaying the QR code on the QR code display object 30 is printing, embossing work, intaglio work, or the like.

In this way, the QR code display object 30 of the present invention covers cases where a QR code is displayed directly on a corresponding product without any medium.

For example, as shown in FIG. 2(b), a QR code may be displayed directly on a suit of clothes as the QR code display object 30 by means of printing or textile printing. As another example, as shown in FIG. 2(c), a QR code may be displayed directly on the surface of a mug as the QR code display object 30 by means of printing with enamel or porcelain ink. As yet another example, as shown in FIG. 2(d), a QR code may be displayed directly on the surface of a nameplate as the QR code display object 30, which is an acrylic or metal pendant hung on a bag, etc., by means of printing, embossing work, or intaglio work.

Further, as shown in FIG. 2(e), the various types of QR code display objects 30 including QR codes displayed on planar sheets, flat plates, three-dimensional objects, and the like may be manufactured such that a transparent layer is interposed between the QR code and an observer. For example, the present invention also covers cases where a QR code is covered with a transparent layer, regardless of the thickness of the transparent layer. As the transparent layer, a highly light-transmissive material such as vinyl or acryl may be used, and the highly light-transmissive material includes translucent or colored materials.

The QR code display objects 30 with QR codes displayed on planar sheets, flat plates, or corresponding products are all ready-made products. Further, the displayed QR codes are ready-made QR codes that are generated in advance. Further, the ready-made QR code cannot be changed in external shape, but information to be displayed when the QR code is scanned can be edited later on.

Further, the QR code may be decorated with at least one design element of a form, a shape, and a color inside or outside thereof. This decoration needs to be carried out within a range not affecting the quality of recognition of the QR code. Further, within a range guaranteeing the quality of recognition of the QR code by an expert technology, decorative elements may also be added to the inside of the QR code. As the design elements, for example, besides a heart shape as shown in the drawing, a water drop shape, a tree shape, or the like surrounding the QR code may be used, and a colored rectangular frame forming the boundaries of the QR code, patterns or colors added in the inner space of the QR code, and the like may also be used.

In this way, since the present invention provides reduced/enlarged QR codes of various sizes or QR codes decorated with design elements that are generated in advance and tested with a validated quality of recognition, and are distributed and sold as ready-made QR code display objects 30, a purchaser can select and purchase a QR code display object 30 suited to his/her taste, and can immediately use the purchased QR code display object 30.

Further, the information to be displayed in a reader when the QR code scanned by the reader may include list information showing the status of the members of an area consisting of spatially divided units. The “area consisting spatially divided units” means a spatial unit that is physically or conceptually assumed, such as a building, a traditional market, an office. Also, the “members” mean individual main constituents, each occupying divided spaces of the area, such as building office occupants, transitional market store occupants, or office employees.

For example, at the entrance of a building, or near or inside the elevator of a building, an information board providing information on office occupants of the building is provided. Further, at the entrance of a traditional market, an information board providing information on store occupants of the market is also provided. Further, at the entrance of a large office, a layout showing seating arrangements of employees is also provided. In this way, at the entrance of an area consisting of spatially divided units, there is provided an information board or an information material, and the present invention makes it possible to substitute a QR code display object 30 for the information board or material. Accordingly, when the status of the members is changed, only the information to be displayed when the QR code is scanned is changed while the QR code and the QR code display object 30 are preserved, resulting in a significant reduction in maintenance and replacement costs.

In this case, when the QR code is scanned by, for example, a user equipment 50 as shown in FIG. 1, the status of the members is displayed as shown in a table at the left lower end. If there is a change in the status of the members, then the user only has to access the editing URL 34 and change the information to be displayed when the QR code is scanned, and the result can be immediately confirmed when the QR code is scanned using the reader function of the user equipment 50.

Preferably, example information for various types of information that may be generally contained in the QR code is included in advance in the information to be displayed in the reader when the QR code is scanned by the reader. In general, the QR code may contain texts, photos, moving pictures, URL information, and the like. Thus, as the example information, one or more texts such as humorous and witty greetings and a self-introduction, one or more photos such as self photos, office building photos and entertainer photos, one or more moving pictures such as trailers of latest movies and self recorded video greetings, and the like may be included in a layout that is efficient and satisfactory in a sense of design. This example information includes layout examples, and it is obvious that even when any one or more of arranged texts, photos, moving pictures, and URL information are blank, the blank space itself may be example information for layout.

In this way, a part of the information contained the QR code displayed on the QR code display object is filled in advance with information for examples of use, and the information for examples of use can be served as usage guides.

The editing URL 34 is a URL representing an editing website where the information to be displayed when the QR code is scanned, that is, the contents of the QR code, can be edited. The editing website may be a website provided by a provider who sells the QR code display object 30, and the editing URL is preferably linked to the editing website only for the purchased QR code display object 30, rather than the general first page of the provider's website. Here, the editing URL 34 may be printed in visible lettering on a part of the QR code display object 30 so as for the purchaser to use it by manual typing 51.

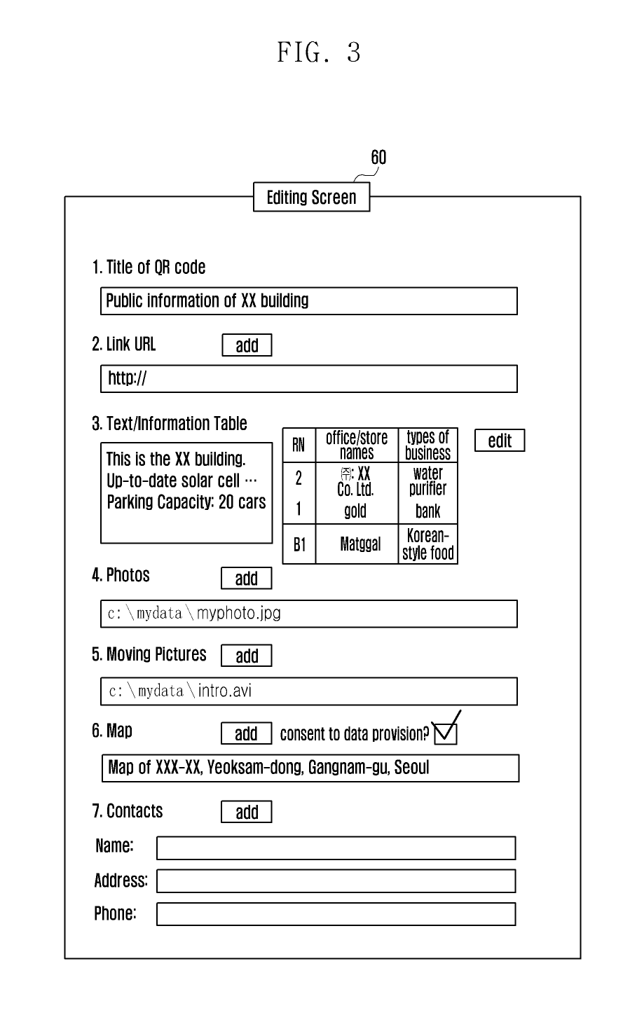

However, the first thing to do after purchasing the QR code display object 30 is to change the temporary contents of the QR code into the purchaser's own regular contents. Accordingly, in consideration of this, it may be convenient to set the editing URL 34 as the URL to be displayed at the scanning 52 of the QR code. [25] With regard to this, the editing URL is configured to be included in the QR code such that the contents to be displayed in the reader when the QR code is scanned correspond to the editing screen of the editing URL. In this case, the editing screen provided by the editing URL 34 is as shown in FIG. 3.

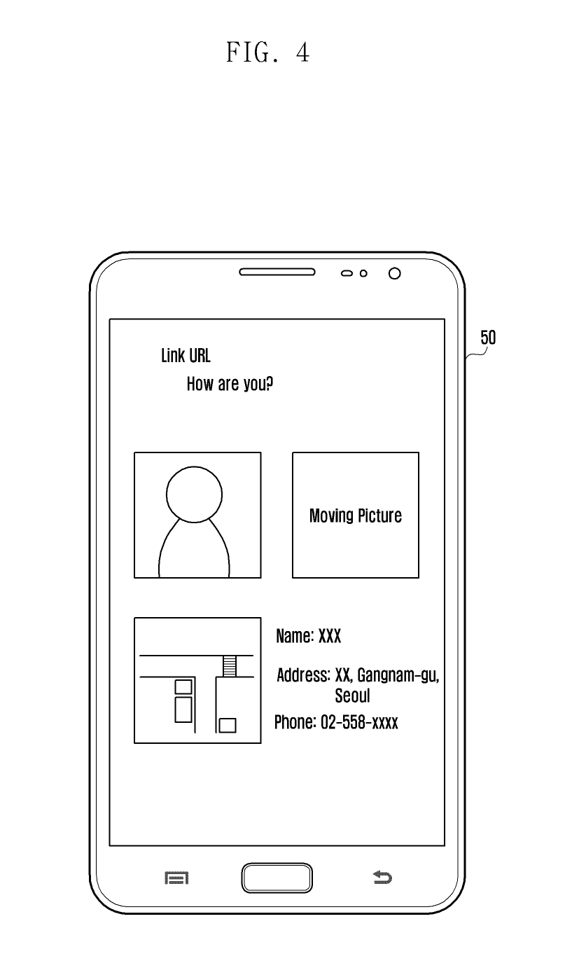

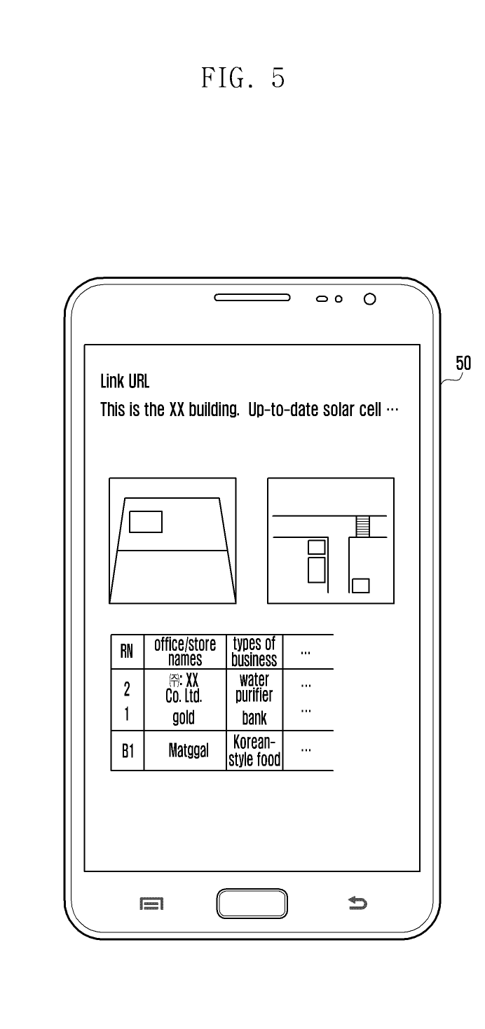

Of course, the initial setting in which the URL to be displayed at the scanning 52 of the QR code is the editing URL 34 is canceled after the first access and logging-in and completion of editing work. That is, since the QR code containing modified contents is stored after the edition of the QR code is completed, the URL to be displayed at the scanning 52 of the regular QR code is now changed to a URL representing the screen configured by the contents contained in or linked to the edited QR code (e.g., the screen of FIG. 4 or 5), rather than the editing URL 34.

The ID 35 is an ID representing authority to edit the information, which is displayed in the reader when the QR code is scanned by the reader, in the editing URL, that is, an ID for logging-in that represents authority to edit the QR code in the editing URL. The purchaser can confirm the editing authority for the QR code display object 30 by inputting the ID 35.

Since the external appearance of the QR code is exposed to the outside, it is preferable to shield the ID 35 from the illegal use of any unauthorized person other than the purchaser. To this end, for example, a known technique such as scratch-type lottery tickets may be used to reveal the ID 35 only by scratching it.

The method of selling a QR code by using the QR code display object 30 according to the present invention is characterized in that the method includes a selling step S12, an accessing step S13, a logging-in step S14, and an editing and storing step S16.

The selling step S12 is the step of distributing and selling the QR code display object 30. Before the selling step S12, the QR code must be generated by the generating module 11 as shown in FIG. 1. In generating the QR code, design elements stored in the design database 15 may be combined with the QR code.

Further, the ID 35 assigned to the QR code is set by the account management module 12, and the QR code with the set ID is registered with the code database 16.

Further, the QR code and ID 35 generated and registered in this way, along with information on the editing URL 34 for providing a function of editing information constituting the contents of the QR code, are manufactured into the QR code display object 30, and the manufactured QR code display object 30 is distributed to and sold through the selling shop 20.

The accessing step S13 is the step in which the purchaser who has purchased the QR code display object 30 accesses the editing URL 34. As described above, when the editing URL 34 is provided in the form of a lettering print, the purchaser can access the editing website by typing the letters into a web browser in a computer or user equipment 50, and when the editing URL 34 is contained in the inside of the QR code, the purchaser can access the editing website by scanning the QR code by a reader.

The logging-in step S14 is the step of logging-in to the account by using the ID 35. The ID 35 may be printed on the QR code display object 30 while being subjected to shielding processing, or may be delivered to the purchaser after the confirmation from a shop clerk of the selling shop 20. Upon inputting the ID 35, the edition function of the editing URL 34 is permitted and activated.

However, in the logging-in step, whether or not the purchaser has a regular ID capable of accessing the editing URL for all the QR codes possessed by the purchaser is be checked, the regular ID may be generated when the purchaser does not have the regular ID (S15), and the ID acquired by purchasing the QR code display object is preferably connected with the regular ID. The regular ID consists of a string of letters in order to facilitate the convenience of memorizing, and can be considered a purchaser-centric ID acting as one ID for all the QR codes possessed by the purchaser.

The editing and storing step S16 is the step of modifying the QR code into the QR code containing desired contents by editing the information constituting the contents of the QR code, and then storing the edited QR code in the account. As described above, a difference between the “temporary” QR code and the “regular” QR code lies in not external shape, but information constituting the contents of the QR code. Accordingly, the external shape of the QR code is completely the same before and after its edition.

FIG. 3 illustrates an example of an editing screen for a ready-made QR code that is included in and provided through a QR code display object according to the present invention.

At the purchase of the QR code display object 30, information for examples of use, that is, example information may be already loaded by the provider. The loaded example information may be confirmed in the editing screen. Referring to the example of FIG. 3, the example information may include the title of the QR code, one or more pieces of URL information, text information such as greetings, one or more pieces of photo information, map information, contact information, and the like, and these information are configured to be deleted or modified by the edition function provided in the editing URL 34.

For example, all the information, particularly except the link URL, may be deleted. In this case, when the completed QR code is scanned, the link URL leads to direct connection to the website linked thereto. Therefore, the QR code is a so-called landing code. Alternatively, for example, only one photo may be replaced by a self photo, and then the remaining example information may be deleted. In this case, when the completed QR code is scanned, only the self photo left undeleted is displayed in the screen of the reader.

Accordingly, the purchaser can reconstruct the QR code into his/her own QR code by editing the information contained in the QR code displayed on the QR code display object.

The “information table” in No. 3 corresponds to an example in which list information showing the status of the members of an area consisting of spatially divided units is contained as the information to be displayed when the QR code is scanned, and the list information may a tool for editing information in a table format. Although only room numbers (RV), office/store names, and types of business are exemplified as the columns, various publicly available information such as phone numbers and homepage addresses may be configured to be editable, and other management information that can be viewed only by the manager of the area, such as information on rents and lease terms, may be configured to be input as private data.

FIG. 4 illustrates a first example of a screen displayed when edition for a ready-made QR code, which is included in and provided through a QR code display object according to the present invention, is completed and then the QR code is scanned. FIG. 5 illustrates a second example of a screen displayed when edition for a ready-made QR code, which is included in and provided through a QR code display object according to the present invention, is completed and then the QR code is scanned.

As shown in FIG. 4, when the QR code is edited, for example, for the personal purpose of the purchaser, greetings, the purchaser's photo, an introduction video, the map of the office, contact information, and the like are displayed on the screen, and the screen may be switched to the webpage linked to the link URL when the purchaser clicks on the URL.

Further, as shown in FIG. 5, when the information to be displayed in the reader when the QR code is scanned is edited to contain list information showing the status of the members of an area consisting of spatially divided units, greetings, the photo of the area (e.g. building), the outline map of the building, the status of the office/store occupants of the building, and the like are displayed on the screen, and the screen may be switched to the webpage linked to the link URL when the purchaser clicks on the URL.

The seller, that is, the provider, may configure a part of the information contained in the QR code as an active means to be used for communication with the purchaser.

To this end, in the editing and storing step, at least a part of the example information included in advance and supplied by the seller as the information to be displayed in the reader when the QR code is scanned by the reader may be set to be non-editable. With regard to this, at least a part of the information set to be non-editable is preferably managed by the seller.

For example, when the QR code is configured to contain 10 moving pictures, 9 of them may be freely edited, set, or modified by the purchaser, but the remaining one moving picture may not be edited, set, or modified by the purchaser. A predetermined connection URL is set at the place where the non-editable moving picture is located, and the seller may provide, for example, advertisements, questionnaires, movie trailers, music videos of singers, funny videos, and the like through the moving picture linked to the connection URL while changing them at any time as needed. However, it is apparent that this scenario is not limited to providing moving pictures, and may be similarly applied to photos, texts, link URL information, and the like.

In this way, the seller can set a part of the information previously filled by the seller to be non-editable by a purchaser and continuously update the information or information connected therewith, thereby utilizing them to provide specific advertisements or useful information.

The present invention also provides a method providing information collected using the QR code display object on the Internet. This method includes an approving step, a collecting step, and a post-processing step.

The approving step is the step in which the seller obtains the purchaser's approval for authority to use the information edited and stored by the purchaser in the editing and storing step. That is, the approval step is the step in which the seller secures approval to use the information, in which the status of the members of the area, edited by the purchaser of the QR code display object 30, is reflected, later on. This may be implemented by inquiring whether the purchaser consents to the agreement while displaying the agreement before terminating the editing screen of FIG. 3.

The collecting step is the step of collecting information for which the purchaser's approval is obtained. Accordingly, the seller can collect information on the status of the members of areas from a plurality of purchasers.

The post-processing step is the step of providing the collected information on the Internet. Accordingly, the collected information on the status of the members of areas can be provided in the Internet map service 70 as illustrated in FIG. 1.

With regard to this, in order to provide the collected information in the post-processing step, the QR code may be displayed on the Internet. Accordingly, the QR code may be displayed on the map as illustrated in FIG. 1, and may be enlarged to a size scannable by the reader when the user clicks on the QR code. If the enlarged QR code is scanned, the information on the status of the members of the corresponding area may be stored in the user equipment 50. This stored information may be used when the user visits the corresponding area.

Although exemplary embodiments of the present invention have been described in detail hereinabove, it should be clearly understood that the present invention is not limited to them, and many variations and modifications, which are made in the scope as defined in the appended claims and are apparent to those skilled in the art, will still fall within the spirit and scope of the present invention.

### Description of Reference Numerals

10 server

11 generating module

12 account management module

13 editing module

14 manufacturing module

15 design database

16 code database

20 selling shop

30 QR code display object

31-33 QR code display objects of various sizes

34 editing URL

35 ID

40 T-shirt (example of corresponding product to which QR code is attached)

50 user equipment

51 typed editing URL and ID

52 scanned QR code

60 example of editing screen

70 map (example)

1. A QR (Quick Response) code display object comprising:
a QR code that is generated in advance and is displayed to be externally recognizable;
an editing URL (Uniform Resource Locator) representing an editing website where information to be displayed in a reader when the OR code is scanned by the reader can be edited; and
an ID (Identification) representing authority to edit the information to be displayed in the reader when the OR code is scanned by the reader,
wherein example information for various types of information containable in the QR code is included in advance in the information to be displayed in the reader when the QR code is scanned by the reader.

2. The QR code display object as claimed in claim 1, wherein the editing URL is included in the QR code such that contents to be displayed in the reader when the QR code is scanned by the reader corresponds to an editing screen of the editing URL.

3. A method of selling a QR code by using the QR code display object as claimed in claim 1, the method comprising:
a selling step of distributing and selling the QR code display object;
an accessing step of accessing the editing URL by a purchaser of the QR code display object;
a logging-in step of logging-in to the editing website by using the ID; and
an editing and storing step of editing the information to be displayed in a reader when the QR code is scanned by the reader and storing the edited information.

4. The method as claimed in claim 3, wherein, in the editing and storing step, at least a part of example information included in advance and supplied by a seller as the information to be displayed in the reader when the QR code is scanned by the reader is set to be non-editable.

5. The method as claimed in claim 4, wherein, in the editing and storing step, at least a part of the information set to be non-editable is managed by the seller.

6. A method of providing information by using a QR code display object, the method comprising:
an approving step of obtaining a purchaser's approval for authority to use information edited and stored by the purchaser in the editing and storing step as claimed in claim 3;
a collecting step of collecting the information for which the purchaser's approval is obtained; and
a post-processing step of providing the collected information on the Internet.

7. The method as claimed in claim 6, wherein, in order to provide the collected information in the post-processing step, the QR code is displayed on the Internet.

8. A ready-made QR (Quick Response) code display object comprising:
a ready-made QR code that is generated for sales in advance, is displayed to be externally recognizable, and is commercially distributed and sold;
an editing URL (Uniform Resource Locator) that is provided separate from a URL representing information to be displayed in a reader when the OR code is scanned by the reader and represents an editing website provided for access of a purchaser of the QR code display object in order to edit and store the information to be displayed in the reader when the OR code is scanned by the reader; and
an ID (Identification) that is used to log-in to the editing URL and represents authority to edit the information, which is to be displayed in the reader when the OR code is scanned by the reader, in the editing URL.

9. The QR code display object as claimed in claim 8, wherein the editing URL is included in the QR code such that contents to be displayed in the reader when the QR code is scanned by the reader corresponds to an editing screen of the editing URL.

10. A ready-made QR (Quick Response) code display object comprising:
a ready-made QR code that is generated for sales in advance and is displayed to be externally recognizable;
an editing URL (Uniform Resource Locator) that is provided separate from a URL representing information to be displayed in a reader when the OR code is scanned by the reader and represents an editing website provided for access of an editor in order to edit and store the information to be displayed in the reader when the OR code is scanned by the reader; and
an ID (Identification) representing authority to edit the information, which is to be displayed in the reader when the OR code is scanned by the reader, in the editing URL,
wherein the information to be displayed in the reader when the QR code is scanned by the reader includes a list information showing a status of members of an area consisting of spatially divided units.

11. A ready-made QR (Quick Response) code display object comprising:
a ready-made QR code that is generated in advance and is displayed to be externally recognizable;
an editing URL (Uniform Resource Locator) that is provided separate from a URL representing information to be displayed in a reader when the OR code is scanned by the reader and represents an editing website provided for access of a purchaser of the QR code display object in order to edit and store the information to be displayed in the reader when the OR code is scanned by the reader; and
an ID (Identification) representing authority to edit the information, which is to be displayed in the reader when the OR code is scanned by the reader, in the editing URL,
wherein the ID comprises a temporary ID, whether or not the purchaser has a regular ID capable of accessing the editing URL for all QR codes possessed by the purchaser when the purchaser logs-in to the editing URL by using the ID is checked, the regular ID is generated when the purchaser does not have the regular ID, and then the temporary ID is connected with the regular ID.
